(19) United States
(12) Patent Application Publication
(10) Pub. No.: US 2023/0150014 A1
(43) Pub. Date: May 18, 2023

(54) METHOD OF MANUFACTURING FORGED PRODUCT

(71) Applicant: SHOWA DENKO K.K, Tokyo (JP)

(72) Inventor: Hideto YOSHIDA, Kitakata-shi (JP)

(73) Assignee: SHOWA DENKO K.K, Tokyo (JP)

(21) Appl. No.: 18/055,909

(22) Filed: Nov. 16, 2022

(30) Foreign Application Priority Data
Nov. 18, 2021 (JP) 2021-187757

(51) Int. Cl. B21K 1/74

(52) U.S. Cl. CPC B21K 1/74; B60G 2206/80; B60G 7/001

(57) ABSTRACT

A method of manufacturing a forged product includes a heating step, a first and a second forging steps, wherein the forging temperature in the heating step is 450° C. or higher and 550° C. or lower, and surface temperatures of the upper molding part of the first upper die in the first forging step and the upper molding part of the second upper die in the second forging step are 150° C. or higher and 190° C. or lower, surface temperatures of the lower molding parts of the first and the second lower dies are 190° C. or higher and 230° C. or lower, and the surface temperatures of the lower molding parts of the first and the second lower dies are higher by 5° C. or more than the surface temperatures of the upper molding parts of the first and the second upper dies.

### BACKGROUND OF THE INVENTION

### Field of the Invention

The present disclosure relates to a method of manufacturing a forged product for manufacturing a forged product of a suspension arm for an automobile.

Priority is claimed on Japanese Patent Application No. 2021-187757, filed on Nov. 18, 2021, the content of which is incorporated herein by reference.

### Description of Related Art

Currently, from the viewpoint of improving the fuel efficiency of automobiles by reducing the weight of vehicle bodies, lightweight aluminum alloy forged bodies have been used as suspension arms such as lower arms or upper arms that are automobile underbody parts. When forging and molding suspension arms, it is common, for example, to heat a straight round bar-shaped aluminum alloy material to a predetermined forging temperature and to produce it by two stages of forging, i.e., crushing and finishing forging (see, for example, Patent Literatures 1 and 2).

As the demand for such aluminum alloy suspension arms increases, in production lines in which suspension arms are produced by hot-forging bar-shaped forging materials, for example, hundreds of thousands of suspension arms per month are mass-produced. A mass production facility for such suspension arms is described in, for example, Patent Literature 3. That is to say, many processes of continuously casting the casting rod of aluminum alloy of relatively small diameter to match the forging of the suspension arm, going through the homogenizing heat treatment, and the hot forging (die forging) such as mechanical forging and hydraulic forging are highly efficient through automation.

The aluminum alloy suspension arm produced in this way constitutes a control arm as an underbody part for an automobile. Suspension arms for an automobile may have non-axisymmetric and complicated shapes in many cases. In addition, while high strength and fatigue strength comparable to steel materials are required, high impact resistance is also required. Therefore, JIS standard 6000 series (Al—Mg—Si series) aluminum alloys are generally used for forging materials for suspension arms. 6000 series aluminum alloys have high strength, high toughness, and excellent corrosion resistance. Furthermore, the 6000 series has excellent recyclability because the amount of alloying elements is small and scrap can be easily reused as 6000 series Al alloy melting raw materials.

As a method of manufacturing such an aluminum alloy suspension arm, for example, Patent Literature 4 discloses hot forging using an upper die and a lower die. According to this, a mold temperature is preferably 100° C. to 300° C. if a suspension arm is made of an aluminum alloy and a forging material temperature is preferably 400° C. to 550° C. if a suspension arm is made of an aluminum alloy.

Also, the forged and molded aluminum alloy suspension arm is then subjected to refining treatment steps such as solution treatment, quenching, and artificial age hardening. In aluminum alloy suspension arms, in order to achieve high strength and toughness, it is important to set the conditions for solution treatment, quenching, and artificial age hardening, as well as controlling the aluminum alloy composition and micro-structure in forging.

Also, as described above, in order to mass produce hundreds of thousands of units per month on an aluminum alloy suspension arm production line, it is also important to improve the efficiency of the refining treatment step.

For this reason, in order to efficiently refine relatively small forged bodies such as suspension arms, generally, a large number of a plurality of forged bodies are arranged by being accommodated in cases and subjected to solution treatment, quenching, and artificial age hardening. Specifically, each of the cases having the plurality of forged bodies accommodated therein is loaded into a solution treatment furnace, a quenching water tank, and an artificial age hardening furnace for each case without transferring the forged bodies in the case for each individual step and the plurality of forged bodies are processed in a batch.

Moreover, in the quenching step, for efficiency, the cases in which the plurality of forged bodies are arranged are stacked in an upward/downward direction and submerged in a quenching water tank are subjected to quenching. That is to say, quenching is performed on a large number of the plurality of forged bodies made of an aluminum alloy which are arranged by being stacked in a batch at the same time.

However, as described above, when a plurality of relatively small forged bodies are arranged in each of the cases and the cases are stacked in the quenching step, there is a problem in which a temperature distribution of cooling water for cooling the forged bodies is likely to be non-uniform and a cooling speed is likely to differ for each of the forged bodies. This is because the forged bodies in the case are accommodated in a state of being densely arranged by arranging the plurality of forged bodies and stacking them for efficiency of quenching.

That is to say, the forged bodies arranged on the upper and middle sides of the arrangement and stacking in the case are less likely to have enough space for each other (gap, interval) to come into contact with the relatively cold cooling water that has just been supplied. For this reason, only the cooling water that has become hot by cooling the forged bodies located on the lower and peripheral sides will come into contact with these forged bodies arranged on the upper and central sides and a difference in water temperature of the cooling water coming into contact with the forged bodies may occur depending on locations thereof arranged in the case in some cases.

On the other hand, in order to forge and mold the high-strength suspension ann, it is necessary to rapidly cool the forged bodies through the quenching step after the solution treatment. On the other hand, however, the higher the cooling speed during the quenching, the more likely that quenching strain (bending of the forged bodies) occurs. There is a concern that a suspension arm with quenched strain may interfere with other components when assembled to a vehicle.

In order to suppress the occurrence of quenching strain in such quenching treatment step, it is conceivable to increase the temperature of the cooling water and decrease the cooling rate, and but, there is a concern that the suspension arm will not be strong enough because of the reduced cooling rate.

For this reason, for example, Patent Literatures 5 and 6 disclose the use of jigs that individually constrain aluminum alloy forged bodies during quenching treatment to suppress strain. Furthermore, Patent Literatures 5 and 6 also disclose adding additive agents such as ethylene glycol to cooling water.

### PATENT LITERATURES

[Patent Literature 1] Japanese Unexamined Patent Application, First Publication No. 2015-066572
[Patent Literature 2] Japanese Unexamined Patent Application, First Publication No. 2011-255404
[Patent Literature 3] Japanese Unexamined Patent Application, First Publication No. 2003-019533
[Patent Literature 4] Japanese Patent No. 5483929
[Patent Literature 5] Japanese Unexamined Patent Application, First Publication No. 2005-146415
[Patent Literature 6] Japanese Unexamined Patent Application, First Publication No. 2005-177861

### SUMMARY OF THE INVENTION

However, although the quenching strain prevention jigs described in Patent Literatures 5 and 6 described above are effective when the forged bodies have simple shapes such as a cylindrical shape, in a forged body having a complex shape such as a suspension arm, there are also many places in which strain occurs and it is difficult to effectively prevent the occurrence of strain in the entire suspensions arm with the jigs. Furthermore, for mass-produced suspension arms, it is not realistic from the standpoint of manufacturing costs to prepare a number of quenching strain prevention jigs corresponding to the number of production type.

On the other hand, in the method of adding an additive agent such as ethylene glycol to the cooling water, the additive agent adheres to the forged body and causes staining. In addition, there is also a problem that the effect of preventing quenching strain is limited.

The present disclosure provides a method of manufacturing a forged product in which quenching strain can be prevented from occurring in a forged body without using an additive agent, a jig, or the like in a quenching step.

An aspect of the present disclosure provides a method of manufacturing a forged product for manufacturing a forged product of a suspension arm for an automobile including at least a heating step of heating a cylindrical forging material made of an aluminum alloy to a forging temperature range; a first forging step of obtaining a first forged body by forging the forging material kept within the forging temperature range between a first upper die having an upper molding part and a first lower die having a lower molding part shaped in a shape of a forged product; a second forging step of obtaining a second forged body by forging the first forged body between a second upper die having an upper molding part and a second lower die having a lower molding part shaped in a shape of a forged product; a solution treatment step of subjecting the second forged body to solution treatment; a quenching step of subjecting the second forged body to quenching; and an age hardening step of obtaining the suspension arm by subjecting the second forged body to age hardening, wherein the forging temperature range in the heating step is within a range of 450° C. or higher and 550° C. or lower, and a surface temperature of the upper molding part of the first upper die in the first forging step and a surface temperature of the upper molding part of the second upper die in the second forging step are within a range of 150° C. or higher and 190° C. or lower, a surface temperature of the lower molding part of the first lower die and a surface temperature of the lower molding part of the second lower die are within a range of 190° C. or higher and 230° C. or lower, and a surface temperature of the lower molding part of the first lower die and a surface temperature of the lower molding part of the second lower die are higher by 5° C. or more than a surface temperature of the upper molding part of the first upper die and a surface temperature of the upper molding part of the second upper die.

According to the aspect of the present disclosure, at the time of manufacturing a suspension arm, it is possible to reduce the strain produced in the second forged body which is forged from the forging material by setting each of the surface temperature of the upper molding part of the first upper die in the first forging step and the surface temperature of the upper molding part of the second upper die in the second forging step to a temperature within the range of 150° C. or higher and 190° C. or lower, setting each of the surface temperature of the lower molding part of the first lower die and the surface temperature of the lower molding part of the second lower die to a temperature within the range of 190° C. or higher and 230° C. or lower, and setting each of the surface temperature of the lower molding part of the first lower die and the surface temperature of the lower molding part of the second lower die to be higher by 5° C. or more than the surface temperature of the upper molding part of the first upper die and the surface temperature of the upper molding part of the second upper die. Thus, the suspension arm for an automobile obtained by subjecting the second forged body to the heat treatment process including the solution treatment step, the quenching step, and the age hardening step can have dimensions as designed, no strain, and high strength.

Also, in the present disclosure, a surface of the forging material may be subjected to a peeling process in advance.

Furthermore, in the present disclosure, the solution treatment step, the quenching step, and the age hardening step may be performed while a plurality of the second forged bodies are accommodated in a storage case in which the second forged bodies are held at a fixed interval so that longitudinal directions thereof are parallel to each other.

In addition, in the present disclosure, in the quenching step, a water temperature of cooling water for quenching and cooling the second forged body may be set to a temperature within a range of 60° C. or higher and 65° C. or lower.

Moreover, in the present disclosure, the aluminum alloy may be a 6000 series aluminum alloy.

An aspect of the present disclosure provides a method of manufacturing a forged product in which quenching strain can be prevented from occurring in a forged body without using an additive agent, a jig, or the like in a quenching process.

### BRIEF DESCRIPTION OF THE DRAWINGS

FIG. 1 is an external perspective view showing an example of a suspension arm for an automobile formed through a method of manufacturing a forged product according to an embodiment of the present disclosure.

FIG. 2 is a flowchart for describing step-by-step the method of manufacturing a forged product of the embodiment of the present disclosure.

FIG. 3 is an external perspective view showing dies used in first and second forging steps.

FIG. 4 is a plan view showing an example of a storage case used in a heat treatment process.

FIG. 5 is an explanatory diagram showing a method of measuring strain in a verification example.

FIG. 6 is a graph for describing the result of a verification example.

### DETAILED DESCRIPTION OF THE INVENTION

A method of manufacturing a forged product of an embodiment of the present disclosure will be described below with reference to the drawings. The embodiments which will be described below are specifically described for better understanding of the gist of the disclosure and do not limit the present disclosure unless otherwise specified. Furthermore, in the drawings used in the following explanation, in order to make it easier to understand the features of the present disclosure, the enlarged main parts may be provided for the sake of convenience in some cases and the dimensional ratio of each constituent element is not necessarily the same as the actual one.

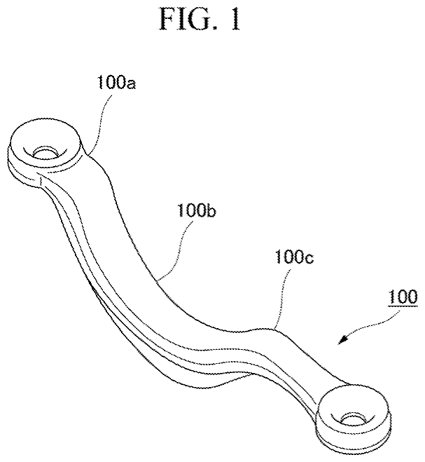

In the following embodiments, for example, suspension arms 100 for an automobile having a form as shown in FIG. 1 is forged and molded. Such suspension arms 100 are arms for controlling the movement of wheels of the automobile and is also called a control arm. Such suspension arms 100 are usually installed one by one on the left and right sides of the vehicle in the direction along the direction of travel, but three to five suspension arms 10 may be used to counteract lateral forces. For this reason, the suspension arms 100 need to be high strength and light weight.

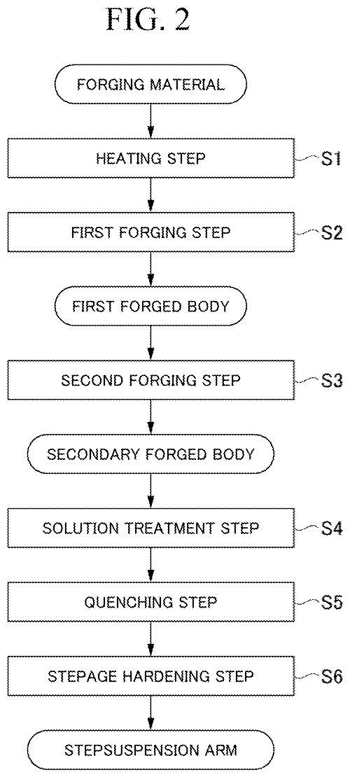

FIG. 2 is a flowchart for describing step-by-step the method of manufacturing a forged product of the embodiment of the present disclosure.

The method of manufacturing a forged product of the embodiment for manufacturing each of the suspension arms 100 as described above sequentially performs steps, that is, a heating step S1 of heating a forging material to have a temperature within a forging temperature range, a first forging step S2 of forging the forging material between a first upper die and a first lower die to obtain a first forged body, a second forging step S3 of forging the first forged body between a second upper die and a second lower die to obtain a second forged body, a solution treatment step S4 of subjecting the second forged body to solution treatment, a quenching step S5 of subjecting the second forged body to quenching, and an age hardening step S6 of subjecting the second forged body to age hardening.

The forging material that is a raw material for manufacturing the suspension arm 100 through the method of manufacturing a forged product of the embodiment may be an aluminum alloy formed into a cylinder shape (round bar shape) and has a diameter of about 40 mm to 60 min and a length of about 500 mm to 600 mm, as a dimension example.

As an aluminum alloy, for example, a 6000 series aluminum alloy specified by JIS may be used, and an Al—Mg—Si based alloy consisting of, as an example of its composition, Si: 0.65 mass % to 0.80 mass %, Fe: 0.20 mass % to 0.40 mass %, Cu: 0.27 mass % to 0.40 mass %, Mn: 0.08 mass % to 0.15 mass %, Mg: 0.97 mass % to 1.20 mass %, Cr: 0.20 mass % to 0.30 mass %, and the balance which may be Al and the inevitable impurities, may be used. Furthermore, the composition may contain B: 0.0001 mass % to 0.03 mass %.

It is preferable that such a forging material is subjected to peeling processing in which an outer circumferential surface is ground to have a predetermined thickness in advance to remove an oxide film so that the circumferential surface is smoothened.

In the heating step S1, the forging material as described above is heated to have the temperature within the forging temperature range. For the heating, a heating furnace may be used for heating a plurality of forging materials in a batch. The forging temperature range of the forging material is a range of 450° C. or higher and 550° C. or lower. In addition, in the embodiment, the forging material is heated to 500° C. Such heating of the forging material increases the plastic flowability of the forging material.

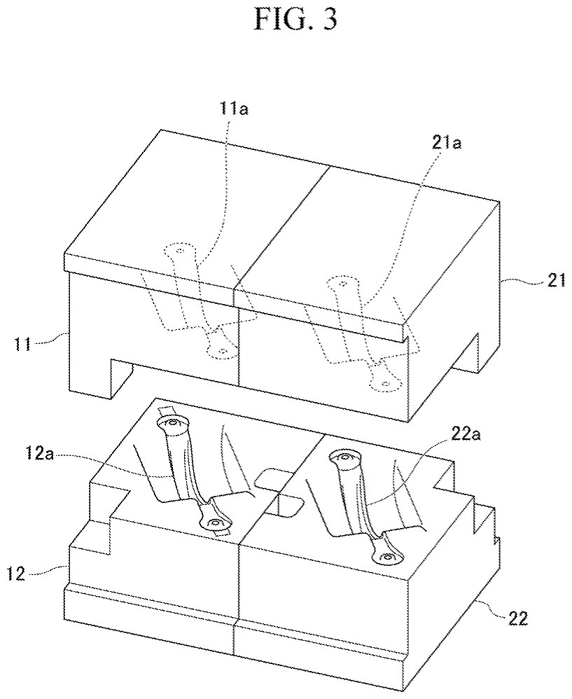

FIG. 3 is an external perspective view showing the dies used in the first forging step S2 and the second forging step S3.

The first forging step S2 is called rough forming and includes forging the forging material heated to have a temperature within the forging temperature range in the heating step S1 into a rough shape of the suspension arm 100 that is a forged product. In the first forging step S2, the first upper die 11 and the first lower die 12 are used.

The first lower die 12 is a fixed die which is fixed to a horizontal pedestal or the like and a lower molding part 12a shaped mainly in a shape of a lower half of the suspension arm 100 that is a forged product is formed for the first lower die 12.

The lower molding part 12a may be a concave part which is open on the side of a surface facing the first upper die 11. During forging, a forging material heated to have a temperature within the forging temperature range is placed on the lower molding part 12a.

The first upper die 11 is a movable die which can move upward and downward in a vertical direction and is moved in an upward/downward direction between a top dead center and a bottom dead center in contact with the first lower die 12 using an upward/downward movement mechanism (not shown) such as a hydraulic cylinder. An upper molding part 11a shaped mainly in a shape of an upper half of the suspension arm 100 that is a forged product is formed for the first upper die 11. The upper molding part 11a may be a concave part which is open on the side of a surface facing the first lower die 12.

In the first forging step S2, heating is performed so that a surface temperature of the upper molding part 11a of the first upper die 11 as described above is a temperature within a range of 150° C. or higher and 190° or lower. Furthermore, heating is performed so that the surface temperature of the lower molding part 12a of the first lower die 12 is a temperature within a range of 190° C. or higher and 230° C. or lower. At this time, the surface temperature of the lower molding part 12a of the first lower die 12 is set to be at least 5° C. higher than the surface temperature of the upper molding part 11a of the first upper die 11.

As an example, in the first forging step S2, the surface temperature of the lower molding part 12a of the first lower die 12 is set to 150° C., the surface temperature of the lower molding part 12a of the first lower die 12 is set to 190° C., and a temperature difference thereof is set to 40° C.

After heating is performed so that the temperatures of the first upper die 11 and the first lower die 12 described above reach predetermined temperatures, the forging material heated to a temperature within the forging temperature range is placed on the lower molding part 12a of the first lower die 12 and the first upper die 11 is moved downward in the vertical direction to the bottom dead center in contact with the first lower die 12, and thus a metal flow (plastic flow) is performed so that the cylindrical forging material spreads in a molding space formed using the upper molding part 11a and the lower molding part 12a and a first forged body which is roughly shaped to be like the suspension arm 100 is obtained.

The first forged body obtained in this way is subjected to the following second forging step S3 while maintaining the forging temperature range.

The second forging step S3 is called finish molding and includes forging the first forged body having a temperature within the forging temperature range into a design shape of the suspension arm 100 that is a forged product. In the second forging step S3, the second upper die 21 and the second lower die 22 are used.

The second lower die 22 is a fixed die which is fixed to the horizontal pedestal or the like and a lower molding part 22a shaped mainly in a shape of the lower half of the suspension arm 100 that is a forged product is formed for the second lower die 22.

The lower molding part 22a may be a concave part which is open on the side of a surface facing the second upper die 21. During forging, the first forged body heated to have a temperature within the forging temperature range is placed on the lower molding part 22a.

The second upper die 21 is a movable die which can move upward and downward in the vertical direction and is moved in the upward/downward direction between a top dead center and a bottom dead center in contact with the second lower die 22 using the upward/downward movement mechanism (not shown) such as a hydraulic cylinder. The upper molding part 21a shaped mainly in a shape of the upper half of the suspension arm 100 that is a forged product is formed for the second upper die 21. The upper molding part 21a may be a concave part which is open on the side of a surface facing the second lower die 22.

In the second forging step S3, heating is performed so that the surface temperature of the upper molding part 21a of the second upper die 21 as described above is a temperature within the range of 150° C. or higher and 190° C. or lower. Furthermore, heating is performed so that the surface temperature of the lower molding part 22a of the second lower die 22 is a temperature within the range of 190° C. or higher and 230° C. or lower. At this time, the surface temperature of the lower molding part 22a of the second lower die 22 is set to be at least 5° C. higher than the surface temperature of the upper molding part 21a of the second upper die 21.

As an example, in the second forging step S3, the surface temperature of the lower molding part 22a of the second lower die 22 is set to 160° C., the surface temperature of the lower molding part 22a of the second lower die 22 is set to 200° C., and a temperature difference is set to 40° C.

After heating is performed so that the temperatures of the second upper die 21 and the second lower die 22 described above reach predetermined temperatures, the first forged body set to a temperature within the forging temperature range is placed on the lower molding part 22a of the second lower die 22 and the second upper die 21 is moved downward in the vertical direction to the bottom dead center in contact with the second lower die 22, and thus a metal flow is performed in a molding space in which the first forged body is formed using the upper molding part 21a and the lower molding part 22a and a second forged body which is precisely finish-forged into the shape of the suspension arm 100 is obtained.

The second forged body immediately after the second forging step S3 is, for example, at about 350° C. After the second forged body is naturally cooled to 300° C. through standing to cool in a room temperature environment, the second forged body is cooled from 300° C. to room temperature using air cooling through blowing air. During this cooling, it is preferable that the second forged body maintain the same posture as when the second forged body is forged. After that, burrs and surplus portions generated during forging of the second forged body are removed.

Subsequently, the second forged body is processed in the order of the solution treatment step S4, the quenching step S5, and the age hardening step S6 that are heat treatment processes.

The solution treatment step S4 is a step of uniformly dissolving undissolved elements in the aluminum alloy to improve corrosion resistance or the like. In the solution treatment step S4, the second forged body is heated up to a solution treatment temperature using, for example, a heating furnace. In the case of an aluminum alloy, for example, the aluminum alloy may be heated up to a temperature within a range of 500° C. or higher and 530° C. or lower.

In the quenching step S5, the second forged body heated up to the solution treatment temperature in the solution treatment step S4 that is a previous step is rapidly quenched and cooled using cooling water. At this time, the water temperature of the cooling water is preferably within the range of 60° C. or higher and 65° C. or lower.

Since an immersion speed of the second forged body heated to the solution treatment temperature in cooling water is very fast in the quenching step S5, if the water temperature of the cooling water is less than 60° C., there is a concern that arm parts 100a, 100b, and 100c (refer to FIG. 1) of the suspension arm 100 that is a second forged body likely to be distorted during quenching. Furthermore, if the water temperature of the cooling water exceeds 65° C., there is a concern that the rapid cooling effect will be reduced. For this reason, the water temperature of the cooling water in a water tank is set within the range of 60° C. or higher and 65° or lower using, for example, a hot water circulation system, a heater, or the like.

The age hardening step S6 is a step of subjecting the second forged body which has been subjected to the quenching step S5 that is the previous step to artificial age hardening using an artificial age hardening furnace. Thus, elements dissolved through supersaturation are artificially precipitated and the crystal strain can increase the hardness of the second forged body.

Such an age hardening step S6 can be performed by heating the second forged body which has been subjected to the quenching step S5, for example, to about 200° C.

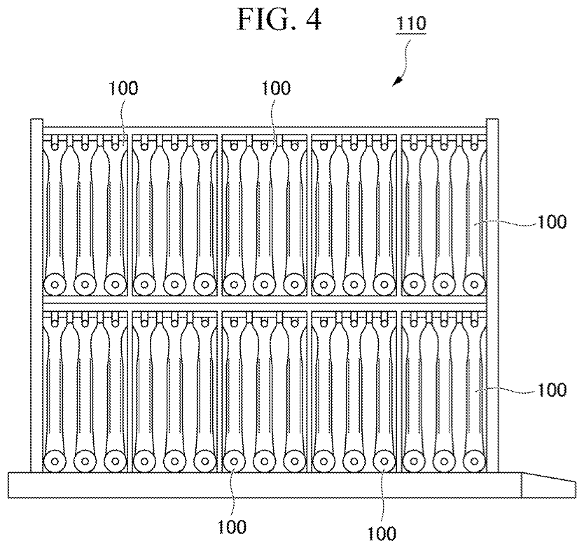

In the heat treatment process including the solution treatment step S4, the quenching step S5, and the age hardening step S6 described above, it is preferable that each heat treatment process be performed while still in a storage case or together with each storage case without transferring a plurality of second forged bodies in each step of the solution treatment step S4, the quenching step S5, and the age hardening step S6 while the second forged bodies are accommodated in a storage case 110 for heat treatment as shown in FIG. 4, for example, to mass-produce hundreds of thousands of suspension arms per month.

The storage case 110 is formed of, for example, a heat-resistant metal and holds a plurality of second forged bodies therein at fixed intervals so that longitudinal directions thereof are parallel to each other. Such a storage case 110 may have any constitution as long as the storage case 110 has a constitution in which heat and cooling water can easily enter the inside thereof.

When such a storage case 110 is used for the heat treatment process, a plurality of relatively small second forged bodies such as suspension arms can be efficiently heat-treated in a batch and the productivity of the suspension arm can be improved.

Through each of the above steps, the suspension arm 100 for an automobile can be produced from the forging material.

As described above, according to the method of manufacturing a forged product of the embodiment of the present disclosure, at the time of forging and molding the suspension arm 100 for an automobile, it is possible to reduce the strain produced in the second forged body which is forged from the forging material by setting each of the surface temperature of the upper molding part 11a of the first upper die 11 in the first forging step S2 and the surface temperature of the upper molding part 21a of the second upper die 21 in the second forging step S3 to a temperature within the range of 150° C. or higher and 190° C. or lower, setting each of the surface temperature of the lower molding part 12a of the first lower die 12 and the surface temperature of the lower molding part 22a of the second lower die 22 to a temperature within the range of 190° C. or higher and 230° C. or lower, and setting each of the surface temperature of the lower molding part 12a of the first lower die 12 and the surface temperature of the lower molding part 22a of the second lower die 22 to be higher by 5° C. or more than the surface temperature of the upper molding part 11a of the first upper die 11 and the surface temperature of the upper molding part 21a of the second upper die 21. Thus, the suspension arm 100 for an automobile obtained by subjecting the second forged body to the heat treatment process including the solution treatment step S4, the quenching step S5, and the age hardening step S6 can have dimensions as designed, no strain, and high strength.

Although embodiments of the present disclosure have been described above, such embodiments are presented as examples and are not intended to limit the scope of the disclosure. These embodiments can be implemented in various other forms and various omissions, replacements, and modifications can be made without departing from the scope of the disclosure. These embodiments and their modifications are included in the scope and the spirit of the disclosure, as well as the scope of the disclosure described in the claims and equivalents thereof.

### EXAMPLES

The Effects of the Present Disclosure were Verified.

### Example 1

A cylindrical aluminum alloy forging material (diameter of 48 mm, length of 543 mm) which was subjected to peeling treatment in advance was prepared and the forging material was heated to 500° C. (heating step). Furthermore, a first forged body was obtained by setting a surface temperature of a molding part of a first upper die shown in FIG. 2 to 150° and a surface temperature of a molding part of a first lower die to 230° C. and subjecting the forging material after heating to rough forming (first forging step).

Subsequently, a second forged body was obtained by setting a surface temperature of a molding part of a second upper die shown in FIG. 2 to 150° C. and a surface temperature of a molding part of a second lower die to 230° C. and subjecting the first forged body to finish molding (second forging step). Furthermore, the second forged body which has reached about 350° C. after the second forging step was cooled to 300° C. through standing to cool, and then cooled to 50° C. through air cooling using a fan from 300° C. or lower. The process was performed while the ambient temperature at this time was kept at room temperature and the posture of the second forged body was maintained. In addition, burrs and surplus portions were removed by trimming the second forged body after cooling and the second forged body having the shape shown in FIG. 1 was prepared.

Also, a suspension arm of Example 1 of the present disclosure was obtained by subjecting the second forged body to heat treatment in the order of a solution treatment step, a quenching step, and an age hardening step, as in the embodiment described above.

### Comparative Example 1

As Comparative Example 1 in the related art, the manufacturing conditions were the same as those of Example 1 of the present disclosure except that a surface temperature of a molding part of a first upper die was set to 230°, a surface temperature of a molding part of a first lower die was set to 150° C., and rough forming (first forging step) was performed and a surface temperature of a molding part of a second upper die was set to 230° C., a surface temperature of a molding part of a second lower die was set to 150° C., and finish molding (second forging step) was performed.

### Comparative Example 2

As Comparative Example 2 in the related art, the manufacturing conditions were the same as those of Example 1 of the present disclosure except that both a surface temperature of a molding part of a first upper die and a surface temperature of a molding part of a first lower die were set to 190° C. and rough forming (first forging step) was performed and both a surface temperature of a molding part of a second upper die and a surface temperature of a molding part of a second lower die were set to 190° C. and finish molding (second forging step) was performed.

A strain of each suspension arm of Example 1 of the present disclosure and Comparative Examples 1 and 2 obtained as described above was measured.

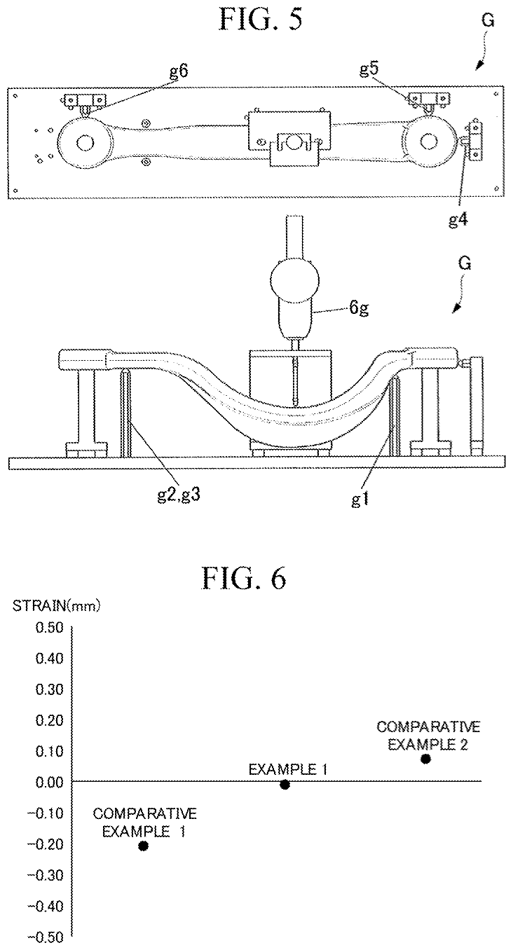

For the measurement, positioning in a height direction was performed at three points g1, g2, and g3 using a gauge device G shown in FIG. 5. Positioning in a longitudinal direction was performed at g4 and positioning in a lateral direction (depth direction in FIG. 5) were performed at g5 and g6. The strain was measured at the point g6 of each suspension arm in which a curvature was large using a linear gauge in a vertical direction. An evaluation method includes adjusting the linear gauge to 0 points using a master sample having a design strain of “0” and defining a difference from that of the master sample as a strain.

Such strain measurement results are shown graphically in FIG. 6.

According to the strain measurement results shown in FIG. 6, the suspension arm of Example 1 of the present disclosure obtained through the method of manufacturing a forged product of the embodiment had a strain value of −0.01 mm. On the other hand, the suspension arm of Comparative Example 1 had a strain value of −0.20 mm and the suspension arm of Comparative Example 2 had a strain value of 0.07 mm. In addition, both of the suspension arms had strains larger than that of Example 1 of the present disclosure.

Therefore, according to the method of manufacturing a forged product of the embodiment, it was confirmed that it is possible to manufacture a suspension arm that has less error than the design value and that prevents strain.

The method of manufacturing a forged product of the present disclosure makes it possible to produce a suspension arm for an automobile having less strain using a round bar-shaped forging material. Therefore, the present disclosure has industrial applicability.

What is claimed is:

1. A method of manufacturing a forged product for manufacturing a forged product of a suspension arm for an automobile, comprising:
at least
a heating step of heating a cylindrical forging material made of an aluminum alloy to a forging temperature range;
a first forging step of obtaining a first forged body by forging the forging material kept within the forging temperature range between a first upper die having an upper molding part and a first lower die having a lower molding part, which are shaped in a shape of a forged product;
a second forging step of obtaining a second forged body by forging the first forged body between a second upper die having an upper molding part and a second lower die having a lower molding part, which are shaped in a shape of a forged product;
a solution treatment step of subjecting the second forged body to solution treatment;
a quenching step of subjecting the second forged body to quenching; and
an age hardening step of obtaining the suspension arm by subjecting the second forged body to age hardening,
wherein the forging temperature in the heating step is within a range of 450° C. or higher and 550° C. or lower, and
a surface temperature of the upper molding part of the first upper die in the first forging step and a surface temperature of the upper molding part of the second upper die in the second forging step are within a range of 150° C. or higher and 190° C. or lower, a surface temperature of the lower molding part of the first lower die and a surface temperature of the lower molding part of the second lower die are within a range of 190° C. or higher and 230° C. or lower, and the surface temperature of the lower molding part of the first lower die and the surface temperature of the lower molding part of the second lower die are higher by 5° C. or more than the surface temperature of the upper molding part of the first upper die and the surface temperature of the upper molding part of the second upper die.

2. The method of manufacturing a forged product according to claim 1, wherein a surface of the forging material is subjected to a peeling process in advance.

3. The method of manufacturing a forged product according to claim 1, wherein the solution treatment step, the quenching step, and the age hardening step are performed while a plurality of the second forged bodies are accommodated in a storage case in which the second forged bodies are held at a fixed interval so that longitudinal directions thereof are parallel to each other.

4. The method of manufacturing a forged product according to claim 2, wherein the solution treatment step, the quenching step, and the age hardening step are performed while a plurality of the second forged bodies are accommodated in a storage case in which the second forged bodies are held at a fixed interval so that longitudinal directions thereof are parallel to each other.

5. The method of manufacturing a forged product according to claim 1, wherein, in the quenching step, a water temperature of cooling water for quenching and cooling the second forged body is set to a temperature within a range of 60° C. or higher and 65° C. or lower.

6. The method of manufacturing a forged product according to claim 2, wherein, in the quenching step, a water temperature of cooling water for quenching and cooling the second forged body is set to a temperature within a range of 60° C. or higher and 65° C. or lower.

7. The method of manufacturing a forged product according to claim 3, wherein, in the quenching step, a water temperature of cooling water for quenching and cooling the second forged body is set to a temperature within a range of 60° C. or higher and 65° C. or lower.

8. The method of manufacturing a forged product according to claim 4, wherein, in the quenching step, a water temperature of cooling water for quenching and cooling the second forged body is set to a temperature within a range of 60° C. or higher and 65° C. or lower.

9. The method of manufacturing a forged product according to claim 1, wherein the aluminum alloy is a 6000 series aluminum alloy.

10. The method of manufacturing a forged product according to claim 2, wherein the aluminum alloy is a 6000 series aluminum alloy.

11. The method of manufacturing a forged product according to claim 3, wherein the aluminum alloy is a 6000 series aluminum alloy.

12. The method of manufacturing a forged product according to claim 4, wherein the aluminum alloy is a 6000 series aluminum alloy.

13. The method of manufacturing a forged product according to claim 5, wherein the aluminum alloy is a 6000 series aluminum alloy.

14. The method of manufacturing a forged product according to claim 6, wherein the aluminum alloy is a 6000 series aluminum alloy.

15. The method of manufacturing a forged product according to claim 7, wherein the aluminum alloy is a 6000 series aluminum alloy.

16. The method of manufacturing a forged product according to claim 8, wherein the aluminum alloy is a 6000 series aluminum alloy.
